(19) United States
(12) Patent Application Publication
(10) Pub. No.: US 2007/0029120 A1
(43) Pub. Date: Feb. 8, 2007

(54) HYBRID VEHICLE

(76) Inventors: Mikio Saitou, Iwata-shi (JP); Katsuhiro Arai, Iwata-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/457,782

(22) Filed: Jul. 14, 2006

Related U.S. Application Data
(63) Continuation of application No. PCT/JP05/00795, filed on Jan. 17, 2005.

(30) Foreign Application Priority Data
Jan. 16, 2004 (JP) 2004-009857

(51) Int. Cl. B60K 1/00

(52) U.S. Cl. 180/65.2

(57) ABSTRACT

A hybrid vehicle that can reduce power consumption when an engine of the vehicle is restarted. The hybrid vehicle has a generator-motor that generates electric power. An engine drives the generator-motor. A battery stores the electric power. In one arrangement, the generator-motor starts the engine by being supplied with the electric power stored in the battery. A control device regulates an upper limit of the electric power that is used to activate the generator-motor.

### PRIORITY INFORMATION

This application is a continuation of International Application PCT/JP2005/000795, with an international filing date of Jan. 17, 2005 and published in English on Jul. 28, 2005, which claims priority under 35 U.S.C. § 119(a)-(d) to Japanese Patent Application No. 2004-009857, filed Jan. 16, 2004, the entire contents of both applications are hereby expressly incorporated by reference herein.

### BACKGROUND OF THE INVENTION

1. Field of the Invention

The present invention generally relates to a hybrid vehicle, and more particularly to an improved hybrid vehicle that has a generator and an engine driving the generator.

2. Description of the Related Art

Recently, hybrid vehicles such as, for example, automobiles, motorcycles and motor scooters have become popular because those vehicles can provide a number of advantages such as, for example, contribution to the protection of the environment. Various hybrid systems can apply to the vehicles.

In one arrangement of the hybrid systems, a vehicle can incorporate a generator, an engine directly coupled with the generator, an electric motor for driving wheels and a battery. The engine is operated to drive the generator so as to supply electric power to the battery when electric power stored in the battery is less than a preset amount. Also, the engine is stopped to discontinue the supply of the electric power to the battery when the electric power is greater than the preset amount. The electric motor is supplied with the electric power to drive the wheels. For example, Japanese patent publication JP06-245317A discloses such an arrangement of the hybrid system.

The generator can be used as a starter motor for starting or restarting the engine. The electric power stored in the battery can be supplied to the generator when the generator is used as the starter motor. Japanese patent publication JP08-35470A, for example, discloses an arrangement of this use.

The generator, however, needs a relatively large amount of the electric power to start the engine. Typically, the engine is restarted when the electric power stored in the battery decreases while the vehicle is traveling. If the generator consumes such a large amount of power to restart the engine, the hybrid system can lose power to continue working.

### SUMMARY OF THE INVENTION

An aspect of the present invention involves the recognition of the need for a hybrid vehicle that can reduce power consumption when an engine of the vehicle is restarted.

To address such a need, an aspect of the present invention involves a hybrid vehicle comprising a generator that generates electric power, an engine that drives the generator, a battery that stores the electric power, an engine starting device that starts the engine by being supplied with the electric power stored in the battery, and a control device that regulates an upper limit of the electric power that is used to activate the engine starting device.

In accordance with another aspect of the present invention, a hybrid vehicle comprises a generator that generates electric power, an engine that drives the generator, the engine having a cylinder, a battery that stores the electric power, an engine starting device that starts the engine by being supplied with the electric power stored in the battery, and a control device that controls the engine to decompress inside of the cylinder when the engine is started by the engine starting device.

In accordance with still another aspect of the present invention, a hybrid vehicle comprises a generator that generates electric power, an engine that drives the generator, a battery that stores the electric power, an engine starting device that starts the engine, a rotational speed detecting device that detects a rotational speed of the generator, and a control device that determines whether the rotational speed of the generator reaches a preset speed, wherein the control device regulating an upper limit of the electric power that is used to activate the engine starting device until the rotational speed of the generator reaches the preset speed.

In accordance with a further aspect of the present invention, a method is provided for controlling a hybrid vehicle. The method comprises driving a generator by an engine, generating electric power by the generator, storing the electric power in a battery, stopping the engine, restarting the engine after the engine is stopped using the electric power stored in the battery, and regulating an upper limit of the electric power when the engine is restarted.

In accordance with a still further aspect of the present invention, a method is provided for controlling a hybrid vehicle. The method comprises driving a generator by an engine, generating electric power by the generator, storing the electric power in a battery, stopping the engine, restarting the engine after the engine is stopped, and decompressing inside of a cylinder of the engine when the engine is restarted.

In accordance with a yet further aspect of the present invention, a method is provided for controlling a hybrid vehicle. The method comprises driving a generator by an engine, generating electric power by the generator, storing the electric power in a battery, stopping the engine, restarting the engine after the engine is stopped, detecting a rotational speed of the generator, determining whether the rotational speed of the generator reaches a preset speed, and regulating an upper limit of the electric power that is used to restart the engine until the rotational speed of the generator reaches the preset speed.

### BRIEF DESCRIPTION OF THE DRAWINGS

FIG. 1 illustrates a block diagram showing a hybrid system configured and arranged for a motor scooter in accordance with certain features, aspects and advantages of an embodiment of the present invention;

FIG. 2 illustrates a flow chart of a control program which can be used in conjunction with the hybrid system of FIG. 1;

FIG. 3 illustrates a control map indicating an upper limit current or maximum current of the generator-motor versus a rotational speed of the generator-motor;

FIG. 4 illustrates current waves flowing in respective phases of a generator-motor of the control system; and

FIG. 5 illustrates a pulse line corresponding to one of the current waves of FIG. 4.

### DETAILED DESCRIPTION OF THE PREFERRED EMBODIMENTS

The following will specifically explain embodiments of the present invention with reference to the drawings.

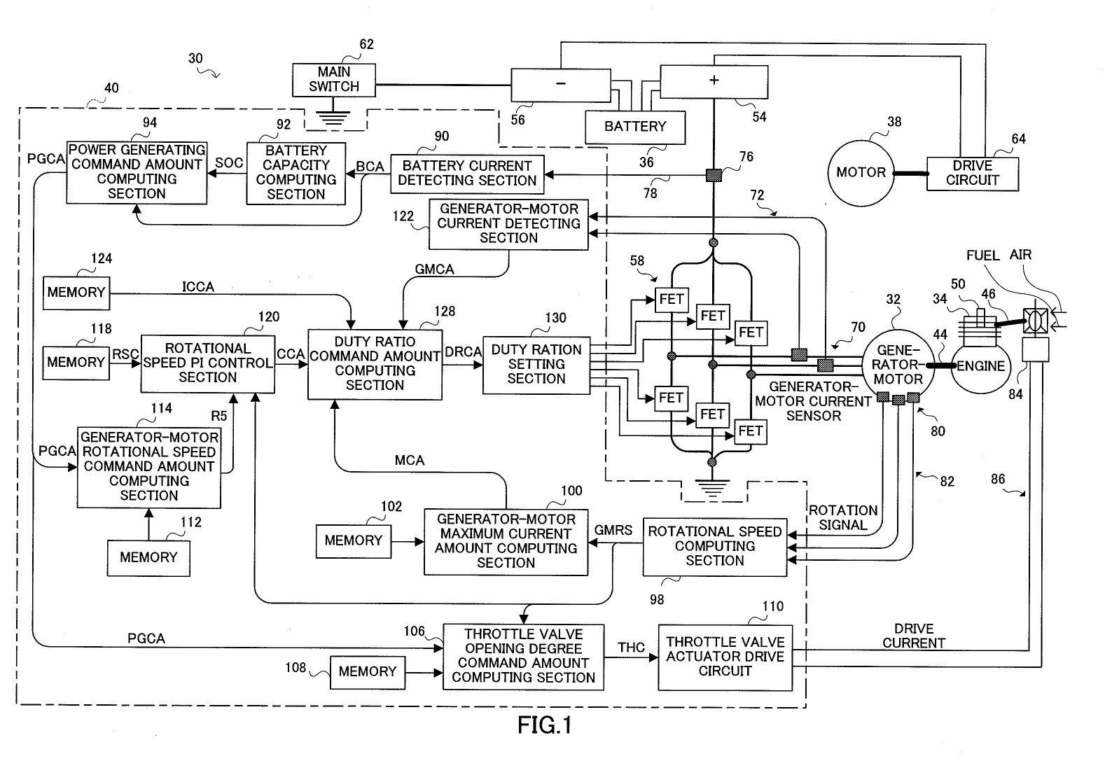

With reference to FIG. 1, a hybrid system 30 configured in accordance with certain features, aspects and advantages of the present invention is described. The illustrated hybrid system 30 applies to a motor scooter. The motor scooter merely exemplifies one type of a vehicle. The hybrid system 30 described below can apply to other types of vehicles such as, for example, motorcycles and automobiles. Such applications will be apparent to those of ordinary skill in the art in light of the description herein. Additionally, the term “hybrid vehicle” means a vehicle that incorporates a hybrid system such as, for example, the illustrated hybrid system 30.

The hybrid system 30 preferably comprises a generator-motor 32, an internal combustion engine 34, a battery 36, an electric motor 38 and a control device 40. In the illustrated embodiment, the hybrid system 30 is one of series type systems. In such a series type system, the engine 34 does not directly drive a propulsive wheel but simply drives the generator-motor 32 to generate electric power. An output of the generator-motor 32 is charged into the battery 36. The electric motor 38 is driven by the electric power stored in the battery 36 to drive the propulsive wheel of the motor scooter. The propulsive wheel preferably is a rear wheel. In general, the control device 40 controls start, stop and restart of the engine by watching a charge condition of the battery 36.

The generator-motor 32 preferably is a three-phase alternator. The generator-motor 32 can selectively act as a generator and a starter motor. That is, the generator-motor 32 can generate electric power when the engine 34 drives the generator-motor 32. On the other hand, the generator-motor 32 can drive the engine 34 to start or restart the engine 34. The generator-motor 32 preferably comprises a stator and a rotor. At least, one of the stator and the rotor can have coils which correspond to the respective phases. The illustrated generator-motor 32 has an output or input shaft 44 connected to the rotor. The shaft 44 can be the output shaft when the generator-motor 32 drives the engine 34. The shaft 44 can be the input shaft when the engine 34 drives the generator-motor 32. Other generators such as, for example, a DC generator can replace the alternator.

The engine 34 preferably is a four-cycle or two-cycle stroke engine, although other types of engines such as, for example, a rotary type engine can be used. The engine 34 has a cylinder body, a crankcase and a cylinder head together defining at least one cylinder bore and a crankcase chamber. A piston is reciprocally disposed within the cylinder bore and defines a combustion chamber together with the cylinder bore and the cylinder head. A crankshaft is rotatably coupled with the piston and rotates within the crankcase chamber when the piston reciprocates within the cylinder bore. The crankshaft preferably is coupled with the output (or input) shaft 44 of the generator-motor 32.

The illustrated engine 34 also has an air intake conduit or air intake device 46 that introduces air into the combustion chamber. An intake valve can be placed to connect or disconnect the combustion chamber with the air intake device 46. A throttle body or air amount adjusting device 48 is disposed at a mid portion or an end portion of the intake conduit 46. The throttle body 48 journals a throttle valve therein such that the throttle valve pivots within the throttle body to move between a fully open position and a fully closed position. When the throttle valve is positioned at the fully open position, the amount of the air can be the maximum because an opening degree of the throttle body 48 is the maximum. When the throttle valve is positioned at the fully closed position, the amount of the air can be the minimum or substantially zero because the opening degree of the throttle body 48 is the minimum or zero. Preferably, an idle air or a nominal amount of air can flow into the combustion chamber even when the throttle valve is positioned at the fully closed position. As thus constructed, the throttle body 48 together with the throttle valve adjusts the amount of the air to the combustion chamber. The greater the opening degree of the throttle body 48, the greater the output of the engine 34.

Preferably, the throttle body 48 has a carburetor or a charge former structure. A fuel supply system preferably is connected to the throttle body 48 to supply fuel into the throttle body 48. Because of the carburetor structure, the fuel is introduced into the intake device 46 together with the air. An amount of the fuel is measured in proportion to the amount of air. Thus, an air/fuel charge or mixture is formed within the combustion chamber of the engine 34.

The engine 34 preferably has an ignition device such as, for example, a CDI (capacitive discharge ignition) system. The ignition device can be connected to the battery 36. A spark plug 50 of the ignition device is exposed into the combustion chamber. The control device 40 can provide an ignition signal to the ignition device to create sparks at the spark plug 50. Each spark of the spark plug 50 can ignite the air/fuel charge in the combustion chamber. The charge thus furiously bums to reciprocally move the piston. With the reciprocal movement of the piston, the crankshaft rotates within the crankcase chamber.

The engine 34 preferably has an exhaust device through which the burnt charges in the combustion chamber (i.e., exhaust gases) are discharged. An exhaust valve can be placed to connect or disconnect the combustion chamber with the exhaust device.

The battery 36 preferably comprises a plurality of secondary cells such as, for example, a nickel type or a lithium type. The secondary cells are rechargeable. The battery 36 preferably has a plus terminal 54 and a minus terminal 56. The plus terminal 54 preferably is connected to output terminals of the generator-motor 32 through a drive circuit or inverter 58. Also, the plus terminal 54 is connected to the control device 40. The plus and minus terminals 54, 56 are connected to the electric motor 38 through a drive circuit or inverter 64. The minus terminal 56 preferably is connected to a main switch or power switch 62. When the main switch 62 is closed (i.e., grounded), the battery 36 can supply the electric power to the electric motor 38, the control device 40 and the ignition device. In addition, when the main switch 62 is closed, the electric power generated by the generator-motor 32 can be charged into the battery 36. When the main switch 62 is opened (i.e., not grounded), the battery 36 is disconnected from the electric motor 38, the control device 40 and the ignition device. Under the condition, the battery 36 cannot supply the electric power to the electric motor 38 and the control device 40. Also, under the condition, the engine 34 cannot start because the ignition device cannot be activated.

Additionally, when a rider of the motor scooter operates a brake device to reduce the speed of the scooter, the electric motor 38 acts as a generator and electric power generated by the electric motor 38 is stored into the battery 36.

As noted above, the generator-motor 32 is connected to the battery 36 through the drive circuit or inverter 58. The drive circuit 58 comprises a plurality of FETS that are disposed to correspond to the respective phases. The illustrated control device 40 switches the respective FETS on or off using a duty ratio control. The duty ratio control of the FET can switch the battery 36 between a charge state and a discharge state and also can change magnitude of the current. The duty ratio control will be described in greater details below.

Generator-motor current sensors 70 preferably are disposed on lines that connect the generator-motor 32 and the drive circuit 58 with each other. In the illustrated embodiment, two current sensors 70 are positioned on two of the three lines. Each current sensor 70 senses a voltage corresponding to a current that flows through the associated line and provides a voltage signal to the control device 40 through each signal line 72. For example, a non-contacting type sensor that detects Hall voltage is available as the current sensor. The control device 40 converts the voltage signal to a current amount signal as described below.

A battery current sensor 76 preferably is disposed on a line that connects the plus terminal of the battery 36 and the drive circuit 58 with each other. The current sensor 76 senses a voltage corresponding to a current that flows through the line and provides a voltage signal to the control device 40 through a signal line 78. The control device 40 also converts the voltage signal to a current amount signal.

The generator-motor 32 preferably has a rotary encoder 80 that detects a rotation of the generator-motor 32. The rotary encoder 80 provides a rotation signal to the control device 40 through signal lines 82.

A throttle valve actuator 84 preferably is affixed to the throttle body 48 to actuate the throttle valve in the throttle body 48. Preferably, the throttle valve actuator 84 comprises a stepping motor. The control device 40 supplies a drive current to the throttle valve actuator 84 through supply lines 86. The throttle valve actuator 84 thus rotates the throttle valve based upon the drive current.

The control device 40 preferably controls the ignition device, the throttle valve actuator 84 and the drive circuit 58 of the generator-motor 32 to start, stop and restart an operation of the engine 34. In the illustrated embodiment, the generator-motor 32 acts as an engine starting device. In one variation, another starter motor can be provided. In order to start or restart the engine operation, the control device 40 preferably controls the drive circuit 58 to rotate the generator-motor 32 under conditions that the control device 40 has activated the ignition device and the throttle valve actuator 84. In order to stop the engine operation, the control device 40 preferably inhibits the ignition device from firing at the spark plug 50 and commands the throttle valve actuator 84 to close the throttle valve so as to discontinue the supply of the air and the fuel to the cylinder of the engine 34. In addition, the control device 40 turns the FETs off to forcibly stop the rotation of the generator-motor 32. The start or restart mode of the engine 34 will be described in greater details below.

In general, the illustrated control device 40 starts or restarts the engine operation when the electric power stored in the battery 36 becomes less than a preset lower limit amount. The control device 40 stops the engine operation when the electric power stored in the battery 36 becomes greater than a preset upper limit amount. In the illustrated embodiment, the battery current signal provided from the battery current sensor 76 is used to determine whether the electric power is less than the preset lower limit amount or whether the electric power is greater than the preset upper limit amount.

Preferably, the control device 40 also restarts the engine operation under a condition that the motor scooter runs in a relatively high speed. Additionally, the control device 40 can start or restart the engine operation when the electric power stored in the battery 36 exceeds the preset upper limit amount to consume the electric power because the overcharge can decrease the life span of the battery 36.

After the control device 40 has started or restarted the engine operation, the illustrated control device 40 increases or decreases the current generated by the generator-motor 32 to control a rotational speed of the generator-motor 32 using a two stage PI (proportion and integral) control. In the first stage of the PI control, if the rotational speed is faster than a command rotational speed, the control device 40 preferably increases the current in a direction in which the rotational speed decreases toward the command rotational speed. If the rotational speed is slower than the command rotational speed, the control device 40 preferably increases the current in a reverse direction in which the rotational speed increases toward the command rotational speed. In order to control the increase or decrease of the current, the control device 40 preferably compares a current command amount and an actual current amount with each other in the second stage of the PI control. If the actual current amount is less than the current command amount, the control device 40 preferably increases the foregoing duty ratio to increase the actual current amount. If the actual current amount is greater than the current command amount, the control device 40 preferably decreases the duty ratio to decrease the actual current amount. Thus, the second stage of the PI control in the illustrated embodiment is the foregoing duty ratio control.

The control device 40 preferably comprises a microprocessor which is a central processor unit (CPU), storage or memory units, input and output units and internal interfaces that connect those units. In this description, the CPU is conveniently indicated as being divided into respective sections. Those sections, however, are not discretely provided and respective functions of the sections can be practiced by at least one program. In other words, the CPU practices the respective functions of the sections in accordance with a control program. Also, the storage or memory units are schematically shown to provide easy understanding of the reader. Actual memory units can be different from those memory units.

The control device 40 preferably has a battery current detecting section 90, a battery capacity computing section 92 and a power generating command amount computing section 94.

The battery current detecting section 90 receives the voltage signal provided from the battery current sensor 76 through the signal line 78. The battery current detecting section 90 converts the voltage to a battery current amount BCA and provides a BCA signal to the battery capacity computing section 92 and the power generating command amount computing section 94.

The battery capacity computing section 92 computes a battery charge capacity or state of charge based upon the current amount BCA and provides an SOC (state of charge) signal to the power generating command amount computing section 94. The SOC signal indicates, for example, a percentage of the electric power in the battery 36.

Upon receiving the SOC signal, the power generating command amount computing section 94 determines based upon the SOC signal whether the engine operation needs to be started (or restarted) or needs to be stopped. Also, the power generating command amount computing section 94 computes a power generating command amount PGCA based upon the BCA signal provided from the battery current detecting section 90 and outputs a PGCA signal. The power generating command amount PGCA is an amount of the electric power that is required to be generated by the generator-motor 32.

In the illustrated embodiment, the control device 40 regulates an upper limit of the electric power that is used to rotate the generator-motor 32 when the generator-motor 32 acts as the engine starting device and particularly until the generator-motor 32 reaches a preset rotational speed. This is because the electric power stored in the battery 36 preferably is saved while the electric motor 38 drives the propulsive wheel (i.e., the rear wheel in this embodiment) of the motor scooter. Thus, the illustrated control device 40 preferably has a rotational speed computing section 98, a generator-motor maximum current amount computing section 100 and a memory 102.

The rotational speed computing section 98 receives the rotation signal provided from the rotary encoder 80 through the signal lines 82. The rotational speed computing section 98 computes the rotational speed of the generator-motor 32 based upon the rotation signal and outputs a generator-motor rotational speed (GMRS) signal. The generator-motor maximum current amount computing section 100 receives the GMRS signal.

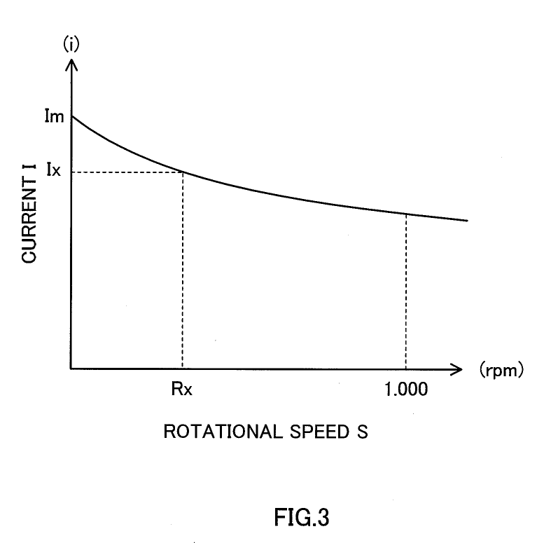

The memory 102 stores a control map or control table that indicates an upper limit current or maximum current of the generator-motor 32 versus a rotational speed of the generator-motor 32. As shown in FIG. 3, the upper limit current I decreases from an initial current amount Im along with the rotational speed S increasing. This is because the electric power P is the product of a torque T and a rotational speed S (i.e., P=TS), and the torque T changes in proportion to the current I (i.e., T=kI (k=constant)).

The generator-motor maximum current amount computing section 100 computes an allowable maximum current amount MCA based upon the GMRS signal provided from the rotational speed computing section 98 and referring to the control map of FIG. 3. The generator-motor maximum current amount computing section 100 then outputs an MCA signal.

The illustrated control device 40 also has a throttle valve opening degree command amount computing section 106, a memory 108 and a throttle valve actuator drive circuit 110.

The throttle valve opening degree command amount computing section 106 receives the PGCA signal provided from the power generating command amount computing section 94. The memory 108 stores a control map indicating a throttle valve opening degree TH versus a power generating command amount PGCA. The throttle valve opening degree command amount computing section 106 computes a throttle valve opening degree command amount THC based upon the PGCA signal and referring to the control map of the memory 108. Preferably, the throttle valve opening degree command amount computing section 106 refers to the control map of the memory 108 when the main switch 62 is turned on. The throttle valve opening degree command amount computing section 106 provides a THC signal to the throttle valve actuator drive circuit 110. The throttle valve actuator drive circuit 110 thus provides the drive current to the throttle valve actuator 84 through the supply lines 86.

The throttle valve opening degree command amount computing section 106 also receives the GMRS signal provided from the rotational speed computing section 98. The throttle valve opening degree command amount computing section 106 determines whether the rotational speed of the generator-motor 32 reaches a preset speed based upon the GMRS signal. In the illustrated embodiment, the preset speed is 1,000 rpm. The throttle valve opening degree command amount computing section 106 provides a special THC signal that indicates zero degree to the throttle valve actuator drive circuit 110 when the control device 40 controls the generator-motor 32 to act as the engine starting device and keeps the special THC signal until the generator-motor 32 reaches the preset speed.

Keeping the throttle valve opening degree zero can make the cranking of the engine 34 easier because the inside pressure of the combustion chamber can be small enough for the piston to easily approach the top dead center. This is because new air is not introduced into the combustion chamber.

In one alternative, the control device 40 can close the intake valve instead of closing the throttle valve. In another alternative, the control device 40 can control the exhaust valve of the engine 34 to open instead of closing the throttle valve or the intake valve. In short, the control device can control the engine to decompress inside of the combustion chamber.

The illustrated control device 40 further comprises a memory 112 and a generator-motor rotational speed command amount computing section 114.

The memory 112 stores a control map indicating a rotational speed of the generator-motor 32 versus a power generating command amount PGCA. The rotational speed stored in the memory 112 is a rotational speed of the generator-motor 32 provided when the generator-motor 32 acts as the generator. The generator-motor rotational speed command amount computing section 114 receives the PGCA signal provided from the power generating command amount computing section 94 and computes a rotational speed RS of the generator-motor 32 when the generator-motor 32 acts as the generator based upon the PGCA signal and referring to the control map of the memory 112. The generator-motor rotational speed command amount computing section 114 thus outputs a RS signal.

The illustrated control device 40 still further comprises a memory 118, a rotational speed PI control section 120 and a generator-motor current detecting section 122.

The memory 118 stores a rotational speed RSC of the generator-motor 32 that is suitable for starting the engine operation (i.e., for cranking). The generator-motor 32 can gradually increase its rotational speed using the rotational speed RSC. The generator-motor current detecting section 122 receives the voltage signals provided from the generator-motor current sensor 70 through the signal lines 72. The generator-motor current detecting section 122 converts the voltages to a generator-motor current amount GMCA and provides a GMCA signal to a duty ratio command amount computing section 128, which will be described shortly.

The rotational speed PI control section 120 receives the GMRS signal provided from the rotational speed computing section 98. The rotational speed PI control section 120 computes a PI control current amount CCA in response to the GMRS signal and referring to the cranking rotational speed of the memory 118 and outputs a CCA signal. This CCA signal is used when the generator-motor 32 acts as the engine starting device. Also, the rotational speed PI control section 120 receives the RS signal provided from the generator-motor rotational speed command amount computing section 114. The rotational speed PI control section 120 computes another PI control current amount CCA in response to the GMRS signal and based upon the RS signal and outputs another CCA signal. This CCA signal is used when the generator-motor 32 acts as the generator.

The illustrated control device 40 yet further has a memory 124, a generator-motor current detecting section 122, the duty ratio command amount computing section 128 and a duty ratio setting section 130.

The memory 124 stores a generator-motor initial current command amount ICCA that is given when the cranking starts. In the illustrated embodiment, the initial current command amount ICCA is a current amount that is generally equal to the maximum current amount Im of FIG. 3 that is provided when the rotational speed of the generator-motor 32 is zero.

When the control device 40 starts or restarts the engine operation and before the cranking starts, the duty ratio command amount computing section 128 reads the generator-motor initial current command amount ICCA from the memory 124. The duty ratio command amount computing section 128 then computes a duty ratio command amount DRCA corresponding to the generator-motor initial current command amount ICCA and provides the DRCA to the duty ratio setting section 130.

Also, when the control device 40 starts or restarts the engine operation and during the cranking, the rotational speed PI control section 120 receives the GMRS signal provided from the rotational speed computing section 98 and the RSC signal provided from the memory 118. The rotational speed PI control section 120 computes the PI control current amount CCA as noted above and outputs a CCA signal to the duty ratio command amount computing section 128. The duty ratio command amount computing section 128 receives the CCA signal provided from the rotational speed PI control section 120 and the MCA signal provided from the generator-motor maximum current amount computing section 100. The duty ratio command amount computing section 128 also receives the generator-motor current amount GMCA signal from the current detecting section 122. The duty ratio command amount computing section 128 computes another duty ratio command amount DRCA in response to the CCA signal, the MCA signal and the GMCA signal. That is, the duty ratio command amount computing section 128 compares the CCA signal and the GMCA signal with each other, and sets the DRCA that does not exceed the MCA based upon a difference between the CCA signal and the GMCA signal. The duty ratio command amount computing section 128 provides the DRCA to the duty ratio setting section 130.

Further, when the control device 40 controls the engine operation after the engine operation has started, the rotational speed PI control section 120 receives the GMRS signal provided from the rotational speed computing section 98 and the RS signal provided from the generator-motor rotational speed command amount computing section 114, and computes another CCA signal as noted above. The rotational speed PI control section 120 provides the CCA signal to the duty ratio command amount computing section 128. The duty ratio command amount computing section 128 receives the CCA signal and the GMCA signal provided from the current detecting section 122. The duty ratio command amount computing section 128 computes a further duty ratio command amount DRCA in response to the CCA signal and the GMCA signal. That is, the duty ratio command amount computing section 128 compares the CCA signal and the GMCA signal with each other, and sets the DRCA based upon a difference between the CCA signal and the GMCA signal. The duty ratio command amount computing section 128 provides the DRCA to the duty ratio setting section 130.

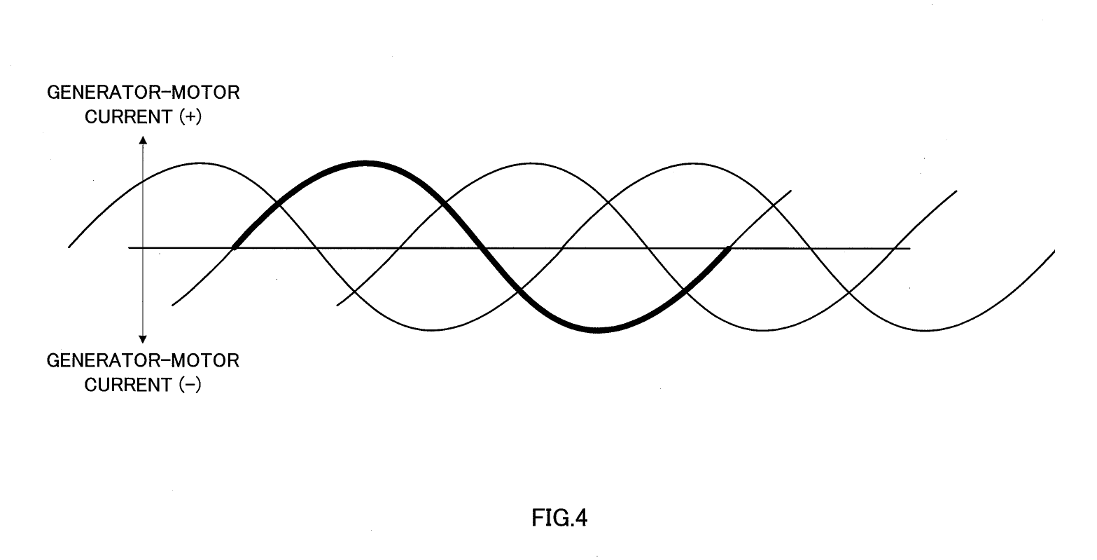

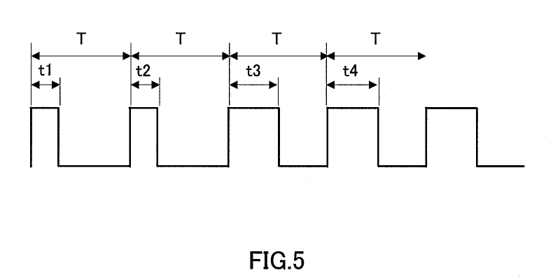

The duty ratio setting section 130 creates drive signals based upon the duty ratio command amount DRCA and drives the respective FETs of the drive circuit 58 using the drive signals. As shown in FIG. 5, each drive signal is a pulse line. A width t1, t2, t3, t4 of each pulse per unit time T can change in accordance with the duty ratio command amount DRCA. Because the respective FETs are switched on or off in response to the pulse line of FIG. 5, the electric power stored in the battery 36 is provided to the generator-motor 32 in complying with the pulse line. Under the condition, currents shown in FIG. 4 flow through the respective coils of the generator-motor 32. The respective current waves are off from one another. The wider the pulse is, the larger the magnitude of the wave is. As a result, the rotor of the generator motor 32 rotates in a speed corresponding to the pulse line of FIG. 5.

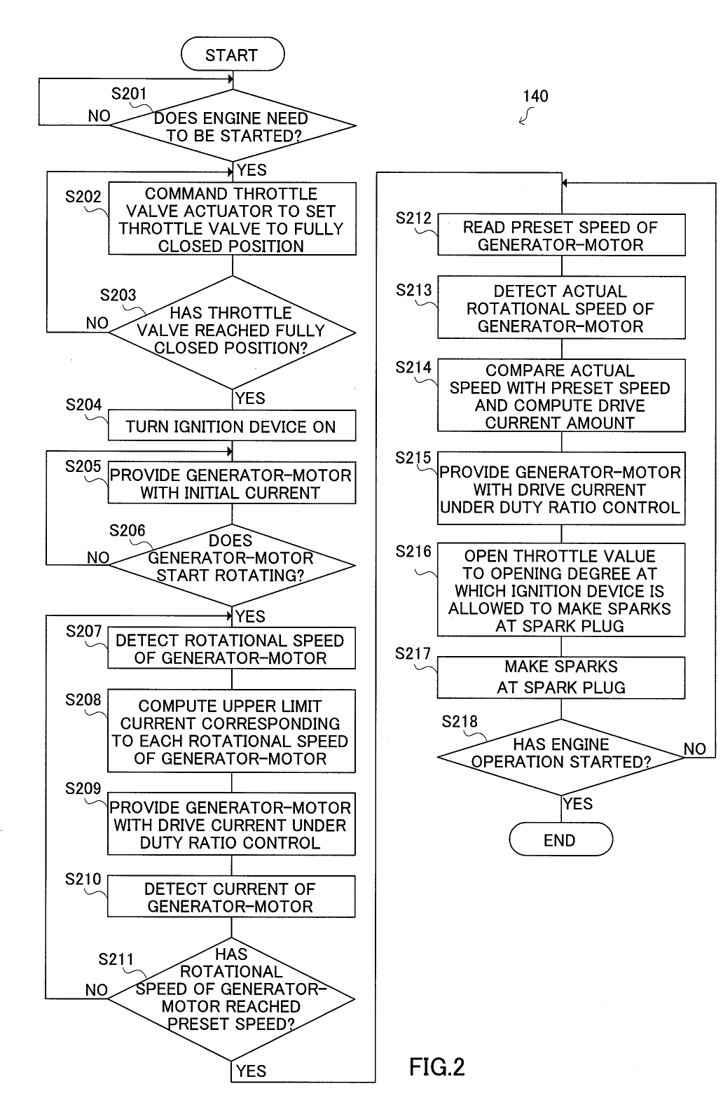

Because the illustrated motor scooter is one of the series type vehicles, the control device 40 restarts the engine operation when the SOC signal indicates that the electric power stored in the battery 36 is less than the preset amount while the electric motor 38 drives the propulsive wheel (i.e., rear wheel). In order to rotate the crankshaft of the engine 34 (i.e., for cranking) under the restart condition, the control device 40 controls the drive circuit 58 and the throttle valve actuator 84 using a control program 140 of FIG. 2.

With reference to FIGS. 1 and 2, a preferable control using the control program 140 is described below.

The control device 40 starts and proceeds to a step S201 to determine whether the engine operation needs to be started. More specifically, upon receiving the SOC signal, the power generating command amount computing section 94 determines whether the engine operation needs to be started based upon the SOC signal. If the determination is negative, the control device 40 repeats the step S201 until the determination becomes positive. If the determination is positive, the control device 40 goes to a step S202.

At the step S202, the control device 40 commands the throttle valve actuator 84 to set the throttle valve to the fully closed position. Specifically, the power generating command amount computing section 94 provides a PGCA signal to the throttle valve opening degree command amount computing section 106. Then, the throttle valve opening degree command amount computing section 106 creates a THC signal indicating the fully closed position of the throttle valve and provides the THC signal to the throttle valve actuator drive circuit 110. The throttle valve actuator drive circuit 110 provides a drive current corresponding to the THC signal to the throttle valve actuator 84. Thus, the throttle valve actuator 84 rotates the throttle valve toward the fully closed position. The control device 40 then goes to a step S203.

The control device 40, at the step S203, determines whether the throttle valve has reached the fully closed position. Because the illustrated throttle valve actuator 84 comprises a stepping motor, the control device 40 can recognize that the throttle valve has reached the fully closed position by watching an elapsed time after providing the command. If the determination is negative and the throttle valve has not yet reached the fully closed position, the control device 40 returns to the step S202. If the determination is positive and the throttle valve has reached the fully closed position, the control device 40 goes to a step S204.

At the step S204, the control device 40 turns the ignition device on. Under this condition, the ignition device does not make a spark at the spark plug 50 yet. The control device 40 goes to a step S205.

The control device 40, at the step S205, controls the drive circuit 58 to drive the generator-motor 32 with the initial current amount that is generally equal to the maximum current amount Im of FIG. 3. Specifically, the duty ratio command amount computing section 128 computes the duty ratio command amount DRCA using the generator-motor initial current command amount ICCA provided from the memory 124 and provides the DRCA to the duty ratio setting section 130. Thus, the duty ratio setting section 130 controls the drive circuit 58 in accordance with the initial duty ratio command amount DRCA (i.e., with the maximum current amount Im). Because the control device 40 uses the maximum current Im at the initial stage, the cranking can be easily started. The control device 40 then goes to a step S206.

At the step S206, the control device 40 determines whether the generator-motor 32 starts rotating. That is, the rotational speed computing section 98 makes the determination based upon the rotation signal provided from the rotary encoder 80. If the determination is negative, the control device 40 returns to the step S205. If the determination is positive, the control device 40 goes to a step S207.

The control device 40, at the step S207, detects a rotational speed of the generator-motor 32. Specifically, the rotational speed computing section 98 computes the rotational speed based upon the rotation signal provided from the rotary encoder 80. The control device 40 then goes to a step S208.

At the step S208, the control device 40 computes an upper limit current amount corresponding to each rotational speed of the generator-motor 32. That is, the generator-motor maximum current amount computing section 100 computes the upper limit current amount based upon the GMRS signal provided from the rotational speed computing section 98 in referring to the control map of FIG. 3 that is stored in the memory 102. For example, if the rotational speed is Rx, the upper limit current amount is Ix as shown in FIG. 3. Then, the control device 40 goes to a step S209.

The control device 40, at the step S209, controls the drive circuit 58 to supply a drive current to the generator-motor 32. Specifically, the duty ratio command amount computing section 128 computes a duty ratio command amount DRCA using the PI control current amount CCA provided from the rotational speed PI control section 120. The duty ratio setting section 130 controls the drive circuit 58 in accordance with the duty ratio command amount DRCA under the condition that the current amount is less than the upper limit current amount. The rotational speed of the generator-motor 32 thus gradually increases toward the preset speed. Also, the electric power used by the generator-motor 32 is regulated under the upper limit. The control device 40 then goes to a step S210.

At the step S210, the control device 40 detects a current amount that flows through the generator-motor 32 under the condition. That is, the current detecting section 122 detects a current based upon the voltages provided from the current sensors 70. The control device 40 goes to a step S211.

The control device 40, at the step S211, determines whether the rotational speed of the generator-motor 32 reaches the preset speed (i.e., 1,000 rpm in the illustrated embodiment). Specifically, the duty ratio command amount computing section 128 makes the determination based upon the current amount provided from the current detecting section 122. This is because the current amount increases in response to the increase of the rotational speed. If the determination is negative, the control device 40 returns to the step S207. In one variation, the output of the rotational speed computing section 98 can be used instead of the current amount. If the determination is positive, the control device 40 goes to a step S212.

In general, at the step S212 and following steps S213, S214 and S215, the control device 40 controls the generator-motor 32 to keep the preset speed.

At the step S212, the rotational speed PI control section 120 reads a rotational speed RSC corresponding to the preset speed from the memory 118. The control device 40 goes to the step S213.

At the step S213, the rotational speed computing section 98 detects an actual rotational speed of the generator-motor 32 using the rotation signal provided from the rotary encoder 80. The rotational speed computing section 98 provides a GMRS signal corresponding to the actual rotational speed to the rotational speed PI control section 120. Then, the control device 40 goes to the step S214.

At the step S214, the rotational speed PI control section 120 compares the GMRS signal (i.e., the actual rotational speed) and the RSC (i.e., the preset speed) with each other. The rotational speed PI control section 120 then computes a control current amount CCA that is necessary to adjust the actual rotational speed to the preset speed and provides the CCA to the duty ratio command amount computing section 128. On the other hand, the current detecting section 122 provides the generator-motor current amount GMCA to the duty ratio command amount computing section 128. Also, the duty ratio command amount computing section 128 compares the CCA and the GMCA with each other and creates a duty ratio command amount DRCA based upon the control current amount CCA and outputs the DRCA to the duty ratio setting section 130. Then, the control device 40 goes to the step S215.

At the step S215, the duty ratio setting section 130 sets the drive circuit 58 in accordance with the DRCA to drive the generator-motor 32. That is, the generator-motor 32 is provided with the control current amount (i.e., drive current) that is necessary to adjust the actual speed to the preset speed.

Because the control device 40 makes the generator-motor 32 keep the preset speed, the generator-motor 32 only consumes a relatively small power during the cranking. This is advantageous particularly when the electric power stored in the battery 36 is short.

Then, the control device 40 goes to a step S216. The control device 40, at the step S216, releases the throttle valve from the fully closed position and allows the throttle valve to move toward an opening degree. This opening degree preferably is the opening degree at which the ignition device is allowed to make sparks at the spark plug 50 and the engine 34 can keep its stable operation. Specifically, the throttle valve opening degree command amount computing section 106 reads the opening degree. The throttle valve opening degree command amount computing section 106 computes a drive amount of the throttle valve actuator 84 based upon the opening degree and outputs a THC signal to the throttle valve actuator drive circuit 110. The throttle valve actuator 110 thus drives the throttle valve using the THC signal until the throttle valve reaches the target opening degree. The control device 40 goes to a step S217.

At the step S217, the control device 40 controls the ignition device to make sparks at the spark plug 50. The control device 40 then goes to a step S218.

The control device 40, at the step S218, determines whether the engine operation has started. Specifically, the duty ratio command amount computing section 128 determines whether the GMCA signal provided from the current detecting section 122 indicates that the direction of the generator-motor current changes. This is because the current of the generator-motor 32 changes its direction when the engine 34 starts and drives the generator-motor 32. If the determination is negative, the control device 40 returns to the step S212. If the determination is positive, the control device 40 ends the control program 140.

As thus described, in the illustrated embodiment, the control device 40 sets the throttle valve at the fully closed position immediately after the control device 40 determines to start the engine and keeps the throttle valve at the fully closed position until the rotational speed of the generator-motor 32 reaches the preset speed. Under the condition, substantially no air is supplied to the combustion chamber of the engine 34. The compression load of the piston can be greatly reduced, accordingly. The engine 34 thus can easily make the cranking. As a result, power consumption of the battery 36 can be small.

The illustrated control device 40 regulates the upper limit of the electric power until the rotational speed of the generator-motor 32 reaches the preset speed. This control contributes to reducing the power consumption of the battery 36.

The illustrated control device 40 regulates the rotational speed of the generator-motor 32 to the preset speed after the rotational speed reaches the preset speed and before the engine 34 starts. This control also contributes to reducing the power consumption of the battery 36.

Also, because the current supplied to the generator-motor 32 is gradually increased before the rotational speed of the generator-motor 32 reaches the preset speed in the illustrated embodiment, the sudden loss of the battery power can be effectively prevented.

Such a small consumption of power is particularly useful when the engine 34 is restarted while the motor scooter is traveling. This is because, as described above, the battery power can become shorter while the motor scooter is in the traveling state than while the motor scooter is in the standstill state.

Further, the illustrated generator-motor 32 can act as a generator and also act as an engine starting device. Thus, the motor scooter can be produced with relatively small cost.

In addition, because the illustrated control device 40 uses the duty ratio control, the control device 40 can easily control the current of the generator-motor 32.

Also, the illustrated battery 36 comprises the secondary cells of the nickel type, the lithium type or the like. Thus, the control device 40 can easily control the drive current supplied to the generator-motor 32 within a certain range that does not involve the maximum charge state.

The throttle valve is not necessarily fully closed. For example, if the throttle valve is adjusted to approach to the closed position more than a position at which the throttle valve is placed immediately before the cranking is started, the compression load of the piston can be reduced.

The crankshaft of the engine can be rotated in a reverse direction so as to set the piston apart from the top dead center previously before the cranking is started. This is advantageous because the piston can vigorously and easily get over the top dead center when the generator-motor rotates the crankshaft in a normal direction. The power consumption thus can be further reduced.

In some arrangements, the rotary encoder and the rotational speed computing section can be omitted. In this alternative, the output of the current detecting section can be used to determine the rotational speed of the generator-motor.

The control device can apply to other types of hybrid systems such as, for example, a parallel type system in which an engine can directly drive a propulsive wheel(s).

Although the present invention has been disclosed in the context of a certain preferred embodiment and examples, it will be understood by those skilled in the art that the present invention extends beyond the specifically disclosed embodiment to other alternative embodiments and/or uses of the invention and obvious modifications and equivalents thereof. It is also contemplated that various combinations or sub-combinations of the specific features and aspects of the embodiment may be made and still fall within the scope of the invention. It should be understood that various features and aspects of the disclosed embodiment can be combined with or substituted for one another in order to form varying modes of the disclosed invention. Thus, it is intended that the scope of the present invention herein disclosed should not be limited by the particular disclosed embodiment described above, but should be determined only by a fair reading of the claims.

This application is based on the Japanese Patent Applications No. 2004-009857 filed on Jan. 16, 2004, entire contents of which are expressly incorporated by reference herein.

An embodiment of the present invention is applicable to an improved hybrid vehicle that has a generator and an engine driving the generator.

What is claimed is:

1. A hybrid vehicle comprising:
a generator that generates electric power;
an engine that drives the generator;
a battery that stores the electric power;
an engine starting device that starts the engine by being supplied with the electric power stored in the battery; and
a control device that regulates an upper limit of the electric power that is used to activate the engine starting device.

2. The hybrid vehicle according to claim 1, further comprising a rotational speed detecting device that detects a rotational speed of the generator,
wherein the control device determines whether the rotational speed of the generator reaches a preset speed, and the control device controls the generator to keep the preset speed when the generator reaches the preset speed.

3. The hybrid vehicle according to claim 1, wherein the control device controls a current of the generator to regulate the upper limit of the electric power.

4. The hybrid vehicle according to claim 1, further comprising a wheel and an electric motor that drives the wheel by being supplied with the electric power stored in the battery,
wherein the control device regulating the upper limit of the electric power when the electric motor drives the wheel.

5. The hybrid vehicle according to claim 1, wherein the engine has a cylinder, and the control device controls the engine to decompress inside of the cylinder when the control device regulates the upper limit of the electric power.

6. The hybrid vehicle according to claim 1, wherein the generator is a generator-motor.

7. The hybrid vehicle according to claim 6, wherein the generator-motor acts as the engine starting device.

8. The hybrid vehicle according to claim 1, wherein the control device controls a pulse line of an electric current to control the electric power supplied to the engine starting device, and the control device increases a width of each pulse per unit time to increase the electric power.

9. The hybrid vehicle according to claim 1, wherein the battery is a secondary cell.

10. A hybrid vehicle comprising:
a generator that generates electric power;
an engine that drives the generator, the engine having a cylinder;
a battery that stores the electric power;
an engine starting device that starts the engine by being supplied with the electric power stored in the battery; and
a control device that controls the engine to decompress inside of the cylinder when the engine is started by the engine starting device.

11. The hybrid vehicle according to claim 10, wherein the engine has an air intake device that supplies air to the cylinder, and an air amount adjusting device that adjusts an amount of the air, and the control device controls the air amount adjusting device to decrease the amount of the air when the engine is started by the engine starting device.

12. The hybrid vehicle according to claim 11, wherein the control device controls the air amount adjusting device to substantially decrease the amount of the air to zero.

13. The hybrid vehicle according to claim 11, further comprising a rotational speed detecting device that detects a rotational speed of the generator,
wherein the control device determines whether the rotational speed of the generator reaches a preset speed, and the control device controls the air amount adjusting device to increase the amount of the air when the rotational speed of the generator reaches the preset speed.

14. A hybrid vehicle comprising:
a generator that generates electric power;
an engine that drives the generator;
a battery that stores the electric power;
an engine starting device that starts the engine;
a rotational speed detecting device that detects a rotational speed of the generator; and
a control device that determines whether the rotational speed of the generator reaches a preset speed,
wherein the control device regulating an upper limit of the electric power that is used to activate the engine starting device until the rotational speed of the generator reaches the preset speed.

15. The hybrid vehicle according to claim 14, wherein the engine has a cylinder, and the control device controls the engine to decompress inside of the cylinder until the rotational speed of the generator reaches the preset speed.

16. A method for controlling a hybrid vehicle comprising:
driving a generator by an engine;
generating electric power by the generator;
storing the electric power in a battery;
stopping the engine;
restarting the engine after the engine is stopped using the electric power stored in the battery; and
regulating an upper limit of the electric power when the engine is restarted.

17. The method according to claim 16, further comprising:
detecting a rotational speed of the generator;
determining whether the rotational speed of the generator reaches a preset speed; and
controlling the generator to keep the preset speed when the determination is positive.

18. The method according to claim 16, further comprising decompressing inside of a cylinder of the engine when the electric power is regulated to the upper limit.

19. A method for controlling a hybrid vehicle comprising:
driving a generator by an engine;
generating electric power by the generator;
storing the electric power in a battery;
stopping the engine;
restarting the engine after the engine is stopped; and
decompressing inside of a cylinder of the engine when the engine is restarted.

20. The method according to claim 19, further comprising decreasing an amount of air introduced into a cylinder of the engine to decompress the cylinder.

21. The method according to claim 20, further comprising:
detecting an engine speed of the engine;
determining whether the engine speed reaches a preset speed; and
increasing the amount of air when the determination is positive.

22. The method according to claim 20, wherein the amount of the air is substantially decreased to zero.

23. A method for controlling a hybrid vehicle comprising:
driving a generator by an engine;
generating electric power by the generator;
storing the electric power in a battery;
stopping the engine;
restarting the engine after the engine is stopped;
detecting a rotational speed of the generator;
determining whether the rotational speed of the generator reaches a preset speed; and
regulating an upper limit of the electric power that is used to restart the engine until the rotational speed of the generator reaches the preset speed.

24. The method according to claim 23, further comprising decompressing inside of a cylinder of the engine.
